(19) United States
(12) Patent Application Publication
(10) Pub. No.: US 2019/0366877 A1
(43) Pub. Date: Dec. 5, 2019

(54) COOLING PLATE AND METHOD FOR PRODUCING SAME

(71) Applicant: REINZ-DICHTUNGS-GMBH, NEU-ULM (DE)

(72) Inventors: ROBERT BLERSCH, BALTRINGEN (DE); GEORG EGLOFF, WEISSENHORN (DE); KURT HOEHE, LANGENAU (DE); GUENTHER UNSELD, NEENSTETTEN (DE)

(21) Appl. No.: 16/485,589

(22) PCT Filed: Feb. 16, 2018
(86) PCT No.: PCT/EP2018/053870

§ 371 Date: Aug. 13, 2019

(30) Foreign Application Priority Data
Feb. 16, 2017 (DE) 10 2017 202 552.2

(51) Int. Cl. B60L 58/26; B23K 1/005; B23K 1/00; B23K 26/244; B23K 26/32

(52) U.S. Cl. CPC B60L 58/26; B23K 1/0056; B23K 2101/14; B23K 26/244; B23K 26/32; B23K 1/0012

(57) ABSTRACT

The present industrial property right relates to a method for producing a cooling plate, to the cooling plate as such and to a battery system and an electric vehicle. According the method for the production of the cooling plate at least two flat metal sections are interconnected by laser beam welding.

The present invention relates to a cooling plate for an electric vehicle, to a battery system, to an electric vehicle, and to a method for producing cooling plates.

In principle, it is known to produce cooling plates from metals. For this purpose, in particular two plate-shaped metal sections, which include channel structures, can be soldered to one another, forming a cooling plate. A cavity through which liquid can be conducted for cooling an electric vehicle is created by the topography of the channel structures between the two metal sections.

Soldered cooling plates can be subject to contamination from flux or solder. In addition, soldering processes, in particular those in which solder is applied to the entire surface, are frequently not economical.

Welding the plate-shaped metal sections together, for example by TIG welding, does not represent an alternative due to the high heat input and the resultant deformation of the metal sections, since cooling plates thus deformed no longer offer a smooth support surface, whereby the efficiency of the cooling system comprising such distorted cooling plates is drastically reduced. Moreover, the weld seams are wider than is desirable. Furthermore, automation would be very complex to achieve, at least in the case of TIG welding, and would be associated with very long cycle times, so that, in addition to technical shortcomings, economic disadvantages also contribute to the need to search for alternative methods.

It is therefore the object of the present invention, among other things, to create a cooling plate that can be produced quickly, easily and cost-effectively and that can be manufactured without distortions, and thus in a geometrically exact manner, in a highly automated process.

This object is achieved by a method for producing a cooling plate, by the cooling plate itself, and by a battery system and an electric vehicle according to the respective independent claims.

Since the joining of the metal section is carried out by way of laser beam welding, forming a cooling plate, additional material is no longer necessarily required in order to join the metal sections to one another. In addition, no contamination from flux, solder or adhesive occurs, and these additional materials also cannot block the cavity (or the channels) resulting between the channel structures. Moreover, laser welding ensures high strength of the welded joint. Especially in peripheral areas, however, a local use of solder (that is, “laser soldering”) may be useful to close potential residual gaps.

A high degree of automation is possible for the method, additional operations, such as coating with solder, are not necessarily required, and the process times can be kept accordingly short. One specific advantage of laser beam welding is that the energy input can be easily metered, and minimal heat input and very fine weld seams can be implemented.

According to one embodiment, the at least two metal sections welded together have an intermittent seam at least regionally so as to reduce the heat input during welding. Such an intermittent weld seam line allows the heat input into the metal sections to be as low as necessary, so that distortion caused by heat can be limited to a tolerable degree.

Refinements are described in the dependent claims.

According to one refinement of the method, the laser welding is carried out by way of a fiber laser, a YAG laser, a CO2 laser or a diode laser. It is advantageous in the process that the intensity of the respective laser beam is variable.

According to one refinement, the laser beam welding is carried out in a laser beam welding device, this device comprising a clamping fixture for fixing the metal sections to be welded together and a beam head for emitting one or more laser beams.

Selectively, the clamping fixture and/or the beam head can be movably guided, so that the clamping fixture and the beam head are displaceable with respect to one another. This can take place, for example, by an axis-guided Cartesian system, which usually can also be automatically controlled.

According to one refinement of the beam head, the beam head comprises a movable mirror system for beam guidance, wherein different areas of the metal sections to be welded together can be activated in accordance with the mirror movement. In this way, (due to the low inertia of the mirrors) extremely rapid welding is made possible, and a weld seam can be readily created on the metal sections at a rate of 4 to 30 m per minute. Likewise, free travel velocities of up to 300 m/min are possible, which allows a highly variable welding sequence.

According to one refinement of the clamping fixture, the metal sections are regionally embraced and/or engaged in a form-locked manner. For example, it is possible to combine pins, so as to avoid displacements in the plane, with plates which provide a limitation perpendicularly thereto. In this way, it is largely avoided that the metal sections become warped due to heat, and reinforcement ribs can be configured so as to reinforce the form-locked clamping fixture.

Moreover, the form-locked embrace makes a large contact surface for heat dissipation possible, and the surface of the clamping fixture oriented toward the metal section can be made of a material that conducts heat particularly well, such as copper or aluminum, for enhanced heat dissipation. For heat dissipation, the device can also be cooled.

According to one refinement of the clamping fixture, sections of the plate-shaped metal sections are arranged on top of one another without gaps during laser welding. By placing the substantially flat sections of the plate-shaped metal sections on top of one another without gaps, it is achieved that the laser beam does not exclusively heat and, in some circumstances, even melt/burn the metal section located closest to the beam head, without a joint being formed with the portion located further away from the beam head.

Moreover, the clamping fixture can comprise a unit for conducting protective gas toward the area to be welded. In this way, a possibly triggered oxidation reaction is stopped and/or cooling of the metal sections is achieved. The protective gas can be conducted on the surface of the metal sections placed on top of one another which is located closer to the beam head or further away from the beam head.

Particularly good confinement of the deformability of the metal sections is achieved in that the clamping fixture, on the top side facing the beam head, includes a radiation cut-out for guiding a laser beam through onto a metal section located on top. This enables access to the weld spot, while allowing heat dissipation in close vicinity thereto. Moreover, it is advantageous that the clamping fixture, on the bottom side facing away from the beam head, includes a welding cut-out to prevent a metal section from being welded in place to the tool of the clamping fixture.

According to refinements of the method, substantially peripheral joining by welding is carried out in the edge region of the metal sections so as to create a liquid-tight cavity between the substantially flat metal sections. This is preferably a continuous seam, and it is possible to provide overlapping welds, in particular in the case of butt joints of two seams (which, for example, can be necessary when reclamping large-surface-area metal sections in the clamping fixture).

So as to create a coolant circuit, the cavity between the metal sections can include one or more openings for supplying and/or removing coolant.

For this purpose, in a first embodiment, a connector can project from at least one metal section, that is, in particular from a planar surface of a metal section, wherein the connector is integrally formed from the metal section. The connector can be formed by stamping or otherwise cutting, for example also by laser cutting, a through-opening, and by embossing and/or deep drawing the edge of the through-opening. A receiving opening for a separate connector can be created analogously.

The aforementioned receiving openings allow a separate connector to be received. This connector preferably comprises a disk- or flange-shaped end piece and is then welded onto the metal section in the region around the through-opening, in particular by way of the disk- or flange-shaped end piece, in particular in a region adjoining the receiving opening.

In a second embodiment, it is possible for such a receiving opening or such a connector not to be formed around a through-opening in a planar surface of a metal section, but in an edge region of the cooling plate. Two edge sections of the two metal sections to be welded together, which end up located on top of one another in the finished cooling plate, are deformed in this process so as to curve away from one another in the finished cooling plate. It is particularly preferred when the curved sections and the neighboring sections protrude beyond the abutting edge of the respective metal section, or when the neighboring sections abut cut-outs, for example slot- or wedge-shaped notches.

After the two metal sections have been placed on top of one another, the neighboring sections located on top of one another of the edge sections curved away from one another are joined to one another at least sectionally, and in particular are welded together. The weld joint can encompass only the two metal sections, or a connector that is introduced into the receiving opening can be directly included in the welding process. A disk- or flange-shaped end piece can be dispensed with in this case, and welding can be carried out directly through the mutually adjoining walls of the receiving opening and connector.

It is particularly advantageous that the plate sections have substantially gap-free joining spots in regions adjoining a cavity. These can essentially be provided as “islands” in the liquid circuit. The islands can have an elongated shape, but alternatively can also be round, oval or rectangular. In one refinement, islands can be omitted in certain regions, so that mixing of the liquid can take place in such a “lake.” The mutually joined regions of the opposing metal sections are joined by weld seams in each case. These weld seams can have different shapes. For example, linear arrangements including weld spots located next to one another are possible (spot welds). However, it is also possible to provide stitch welds (in the form of linear sections that are arranged consecutively, but at a distance from one another). Spot welds and stitch welds are particularly advantageous when a particularly low heat input into the metal sections is intended. Furthermore, circular or oval seal welds within individual islands are possible, and in particular within circular or oval islands. In addition, wave-shaped seams (wave welds) can be used, in particular in the form double wave welds that are phase-shifted with respect to one another. Likewise, mutually overlapping single track seams (wobble welds) are possible. These are particularly preferred when welding is carried out with a very thin laser beam on a highly reflective material, such as aluminum. The mutually overlapping feature of the thin single track seam results in a stable joint, despite limited energy input.

One refinement provides for the thickness of the metal sections in the unwelded state to be 0.2 to 1.5 mm. Materials that can be used for the metal sections include, in particular, aluminum, aluminum alloys, copper, copper alloys, metallized plastic or stainless steel. In the context of the present invention, metal sections also encompass sections made of metallized plastic. Aluminum alloys of the 3xxx and 5xxx groups/series are particularly preferred.

One core aspect of the method for producing a cooling plate for an electric vehicle, in particular for cooling an electric battery of the electric vehicle, is thus that at least two plate-shaped metal sections are joined to one another, forming a cooling plate, wherein the metal sections is joined by laser beam welding. In some embodiments, it is also possible to use solder as an aid, in particular in a locally delimited manner, when direct heating of this solder results in residual sealing, which does not adversely affect flawless functioning of the cooling plate. This can be carried out in peripheral regions, for example.

Refinements provide for opposing metal sections within the liquid-tight cavity of a cooling plate to be welded together so as to form “islands.” These islands are useful both for flow guidance and for stabilizing the plates, in particular when these are made of thin-walled metal sheet, since an “inflation” of the cavity is thereby avoided.

In addition to the weld joints on the surface shown or rendered obvious in the figures, it is also possible to weld in the region of end faces or steps. For example, when edges of metal sections to be joined bear flush on one another, end face welding can be carried out alone and/or in addition. In this way, the sealing action is improved.

In particular when metal sections are to be welded together at edges that are not flush, that is, metal sections of differing sizes and/or surfaces, it is possible to apply fillet welds for joining the same.

In addition to the above-described refinements, it is also possible to reinforce seam ends so as to prevent the seam from “tearing open.” For this purpose, the seam can be continued beyond the actual seam end, so that a continuous seam section is created, which is offset, in particular slightly, with respect to the actual seam and introduced in the opposite direction. The inversion of direction can take place, for example, via a loop-shaped path of a transition seam section.

All of the metal sections described here can, of course, be formed by way of embossing and/or deep drawing and/or hydroforming or other forming processes, configuring at least one channel/cavity. In addition to this depth deformation, however, the metal sections can also be deformed in the surface in such a way that integral tabs are bent out of the plane and/or webs or cups are deep drawn or integrally formed. These are used to attach the battery to the cooling plates or to attach the cooling plates to parts of a vehicle or, for example, also for potential equalization. Appropriate functional elements, however, can also be produced separately and affixed, for example by way of laser welding.

Depending on the desired heat conduction behavior, the metal sections of the cooling plate can differ in terms of composition and shape. For this purpose, it may be provided that two plates made of differing materials and having differing thicknesses/geometries are joined to one another.

Moreover, it may be provided that metal sections comprise connectors that are integrally formed out of the material itself or are affixed as external/additional components (see above). Reference is made here to different arrangements of the connectors (perpendicularly to the main plane/surface plane of the metal sections or in the edge region of this plane and substantially parallel thereto).

It shall be added that, in particular, the separate connectors, which are inserted into a through-opening of a metal section designed as a receiving opening, can also perform additional reinforcing functions. It is possible, for example, that a separate connector is inserted into a through-opening of a metal section in such a way that the connector is supported at least regionally on an opposing metal section, which preferably also delimits a cooling cavity, and, in particular, that the separate connector is welded to the two aforementioned metal sections. In this way, “inflation” of the cavity is avoided.

Furthermore, it is possible for the metal sections or receiving openings to be matched to the connectors in multi-stage forming processes. As was already mentioned, the two metal sections, which bear on one another in a finished cooling plate, together can form a receiving opening in the edge region thereof. For this purpose, the particular edge region of the two metal sections is deformed in each case in such a way that a curvature is obtained which, in a sectional view, is approximately semi-circular, at least sectionally. If the two metal sections are already placed on top of one another after this single-stage forming process, the transition between the individual approximately semi-circular curvatures, that is, from one metal section to the other, is insufficiently shaped. Frequently, the transition from the curvature to the abutting, planar region is too wide and not sufficiently defined. So as to remedy this, a respective subsequent deformation of the edges of the approximately semi-circular curvature is carried out, for example while the metal sections are still separate, so that a considerably more defined edge toward the abutting region and improved rounding of the semi-circular curvature are obtained. As an alternative or in addition, solder can be introduced when the metal sections are still separate, or when these have already placed on top of one another, for example in the form of a solder wire, in particular into a depression provided separately for this purpose. Both the subsequent deformation and the solder allow residual gaps to be closed, either directly or by subsequently, after the metal sections have been placed on top of one another, carrying out laser welding of the metal sections, preferably on both sides, so as to connect a separate connector to the metal sections in the region of the existing residual gaps in a liquid-tight manner.

Moreover, refinements provide that the separate connector is connected to a preferably cup-shaped configuration of a metal section in the region of a through-opening. This allows very easy connection of the connector.

Likewise, a component for influencing the flow can be provided, which is fixed inside a cavity between two metal sections by way of laser welding. For example, a corrugated metal sheet, for example including through-openings, can be used.

The aforementioned features, which are often mentioned in the course of production methods, primarily relate to cooling plates for cooling batteries or other rechargeable batteries in electric vehicles. Separate enumeration of all these features with respect to the present cooling plates is only avoided so as to prevent repetitions; any features, including those that are initially formulated with regard to the method, can be translated into device features with regard to the cooling plate, the battery system or the electric vehicle if needed, if this appears to be useful for delimitation. The present features, where applicable, can be applied directly to the methods and/or can be applied as product-by-process features in the present claims; this applies to all the features from the accompanying method claims.

According to one refinement of the cooling plate, the cooling plate is provided at least regionally with an intermittent seam so as to reduce the heat input during welding. Likewise, a connector can project from at least one metal section or a receiving opening, which is combined with a cup, for example, can be provided, wherein the connector or the receiving opening is integrally formed from the metal section. In particular, when such a receiving opening is present, it is possible to insert or affix, or to insert or affix by welding, a separate connector into such a receiving opening of the metal sections.

According to one refinement, at least one connector and/or a receiving opening are configured on an edge section of the cooling plate, each being configured by an edge section of the two metal sections that are welded together, wherein the two edge sections are welded together at least sectionally. The edge section in which the receiving opening or the connector is configured can extend flush with the abutting edge of the respective metal sections, be separate therefrom by a notch, or protrude in relation thereto.

In general, it is sufficient that the cooling plate according to the invention has a one-layer design with respect to the coolant or the coolant conduction, that is, has only one cavity perpendicularly to the largest extension. This represents a departure from “layering.” Instead, it is attempted to attach a full-surface-area cooling plate even to complicated battery geometries, which due to a limited height also requires little installation height.

In this regard, it is provided in one refinement that the cooling plate is composed of multiple sub-cooling plates, wherein these sub-cooling plates essentially adjoin one another in one plane and preferably are connected to one another by connectors and/or lines for conducting coolant.

The patent application further relates to a battery system for vehicles, comprising a drive battery for the present electric motor and a cooling plate connected to the battery. Finally, an electric vehicle, which comprises an electric motor for driving the vehicle and a battery system, is claimed.

Supplemental refinements are described in the remaining dependent claims.

The invention will be described by way of example based on figures. Identical or similar reference numerals in the individual examples denote identical or similar elements, so that their explanation may not be repeated. The following examples also describe features that are not essential for the invention. In addition to the features that are provided according to the independent claims, these are further optional and advantageous features. These may be used, according to the invention, either alone or in combination with further such features in the respective example, or in combination with further such features in other examples. In the drawings:

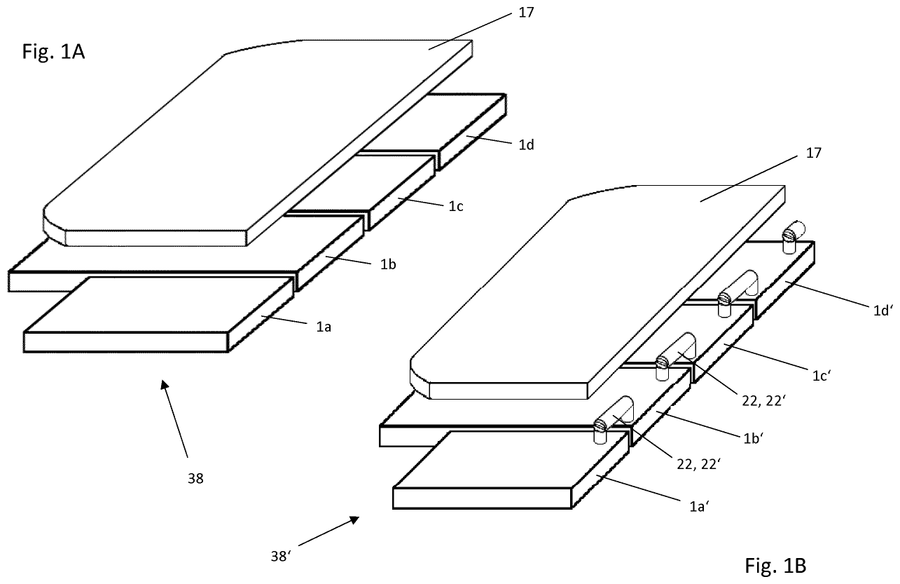

FIGS. 1A and 1B show oblique views of cooling plates according to the invention and of a vehicle drive battery located thereabove for cooling the vehicle drive battery of an electric vehicle;

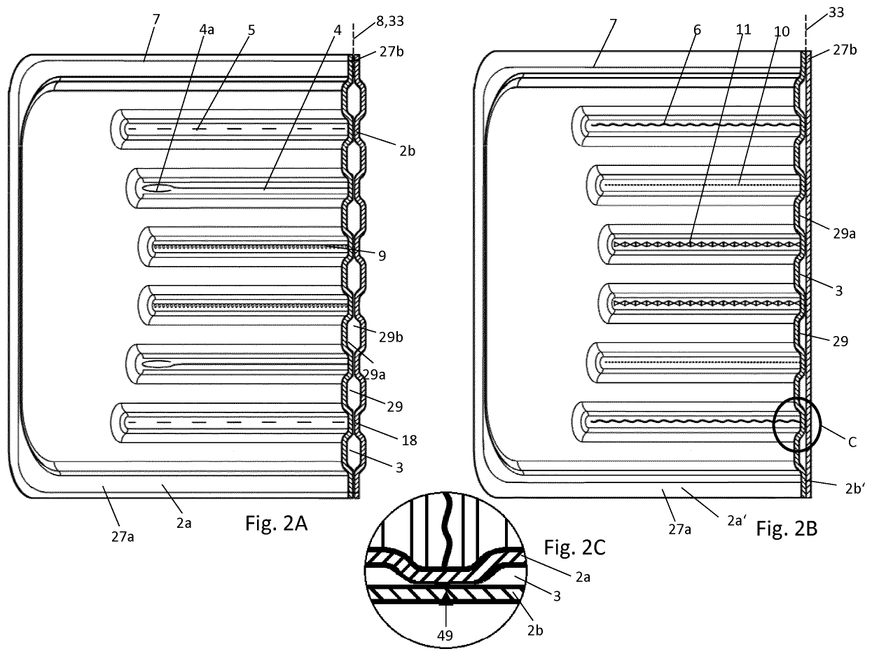

FIGS. 2A to 2C show different embodiments of cooling plates according to the invention comprising different seal welds and an associated detailed view;

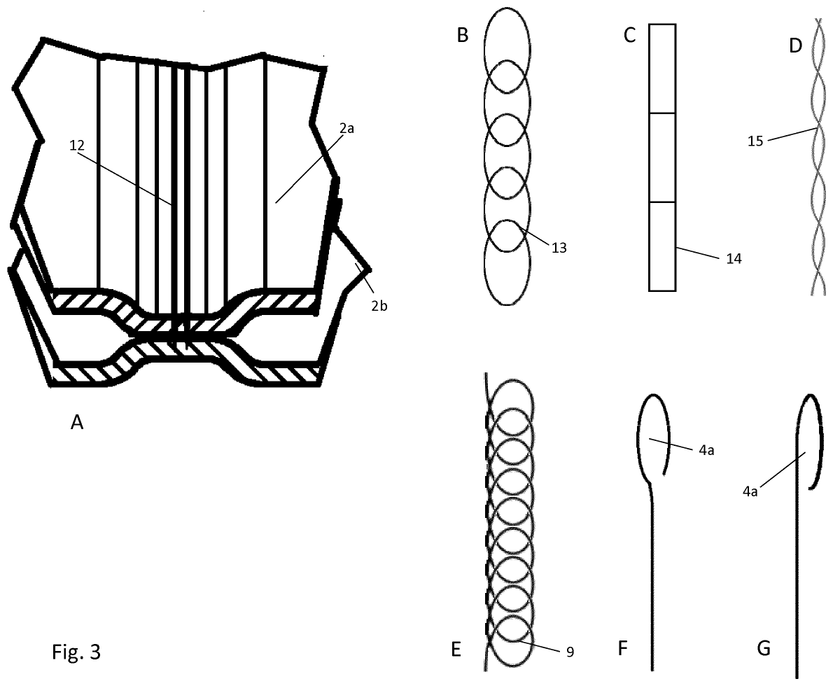

FIG. 3 shows details of weld seams between metal sections joined to one another (variants A to G);

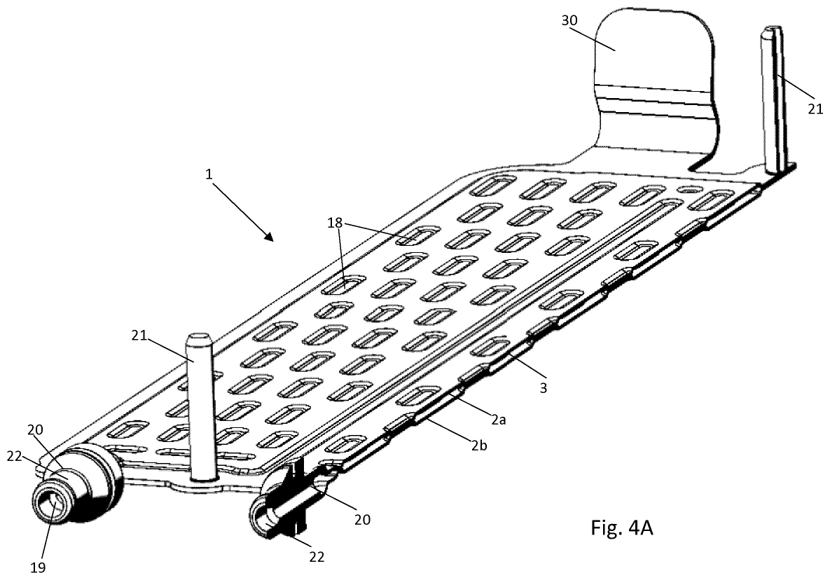

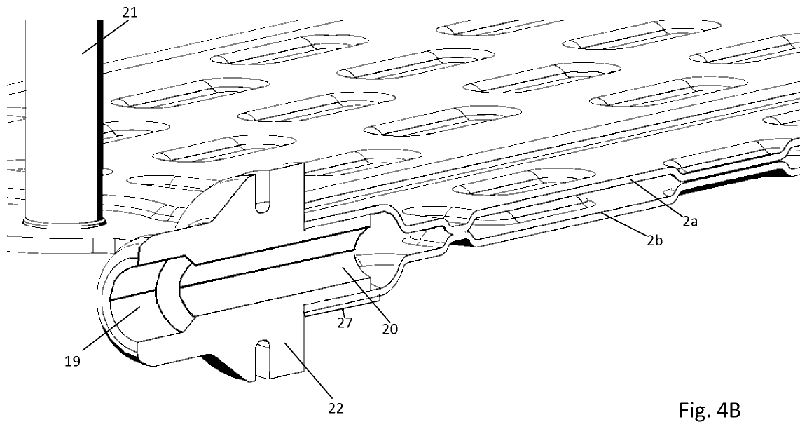

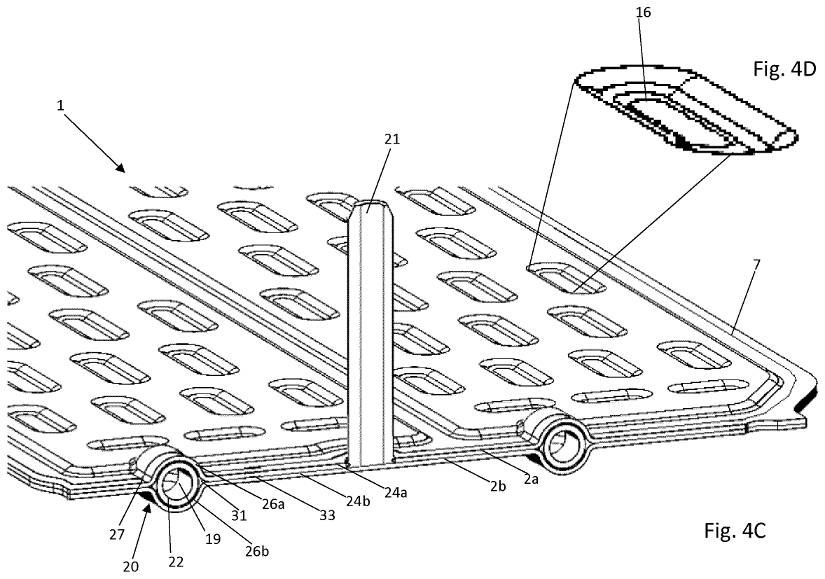

FIG. 4A shows a partial section of a cooling plate according to the invention comprising connected external connectors, a tab protruding from the plane, and bolts for attaching the cooling plate;

FIG. 4B shows a sectional view of a detail from FIG. 4A;

FIGS. 4C and 4D show oblique views of two metal sections of a cooling plate and an associated detailed view;

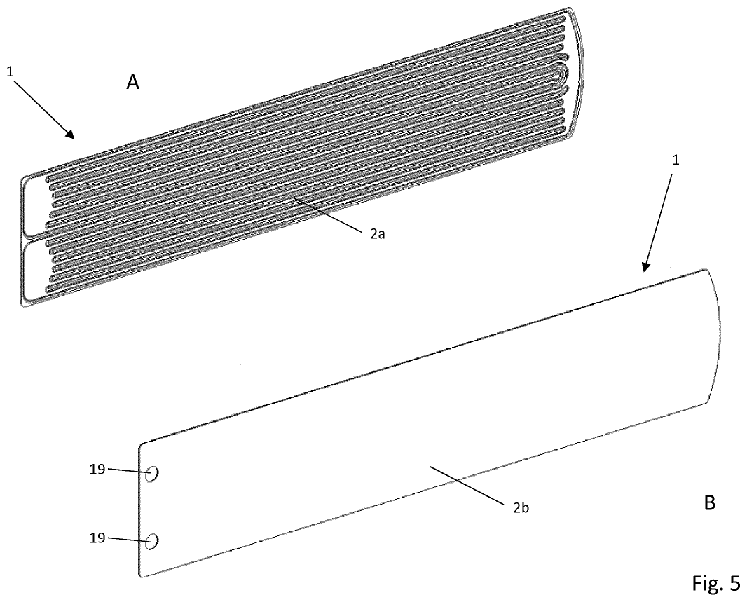

FIGS. 5A and 5B show a top side (A) and a bottom side (B) of two metal sections to be joined to form a cooling plate according to the invention;

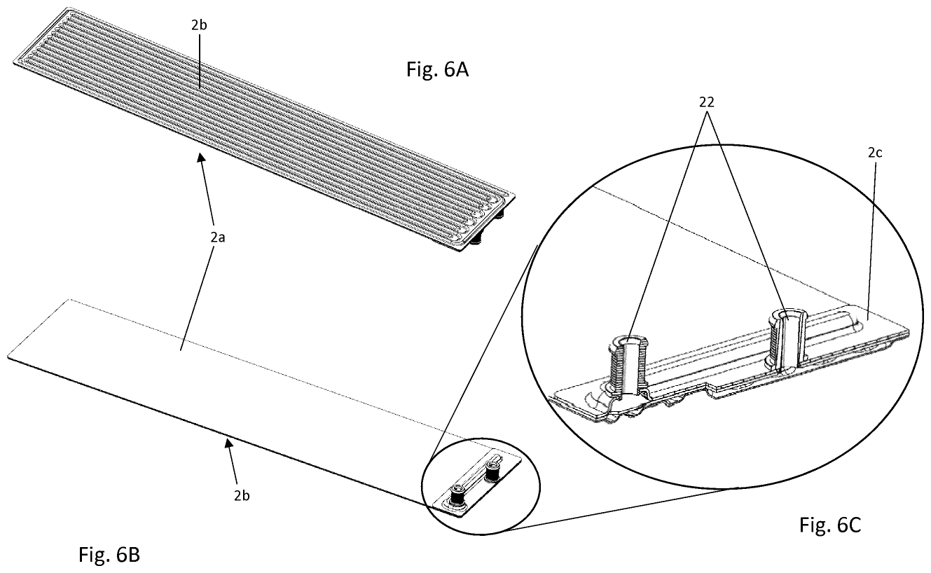

FIGS. 6A to 6C show two top views of a cooling plate according to the invention and details of a cavity of a cooling plate, wherein separate connectors are arranged here, and these connectors are connected to an additional plate (that is, in total, at least three metal sections);

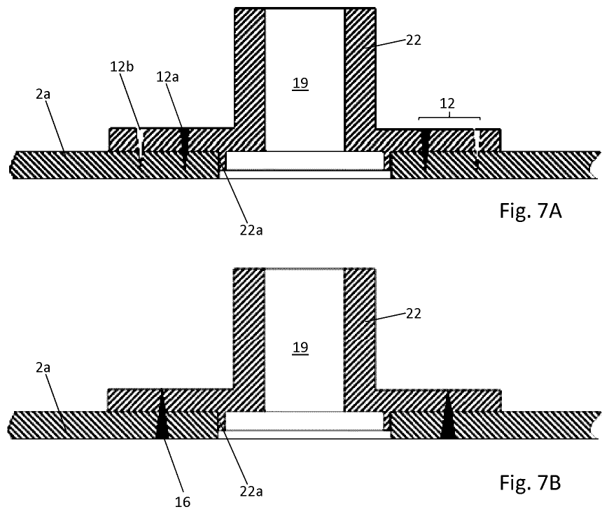

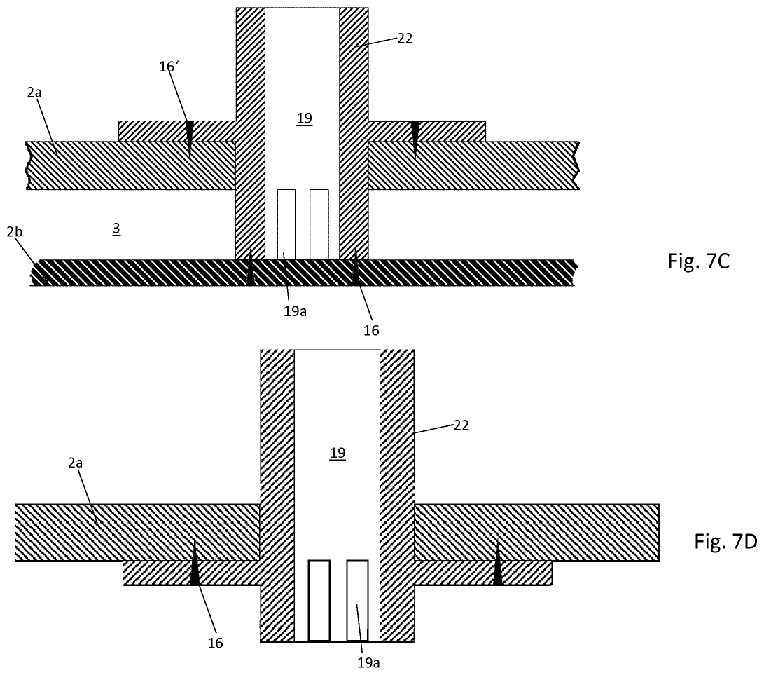

FIGS. 7A to 7D each show details of a sectional view comprising connected external connectors;

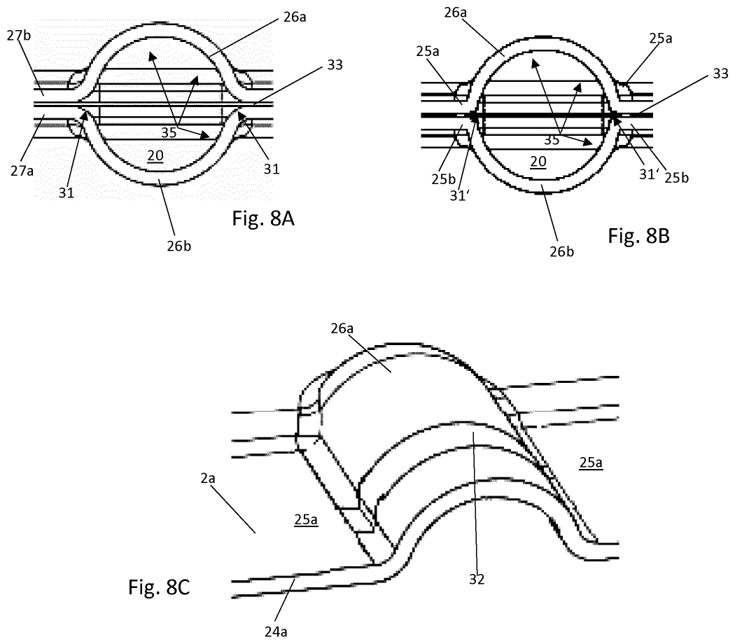

FIGS. 8A to 8C show sectional representations of two metal sections and an oblique view of an individual metal section in the region of a receiving opening in an edge region;

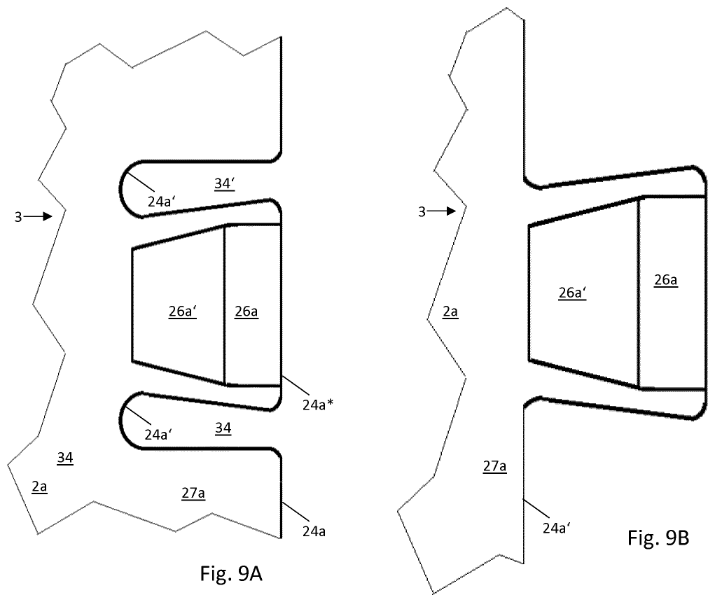

FIGS. 9A and 9B show plan views of edge sections of a metal section in the region of a receiving opening;

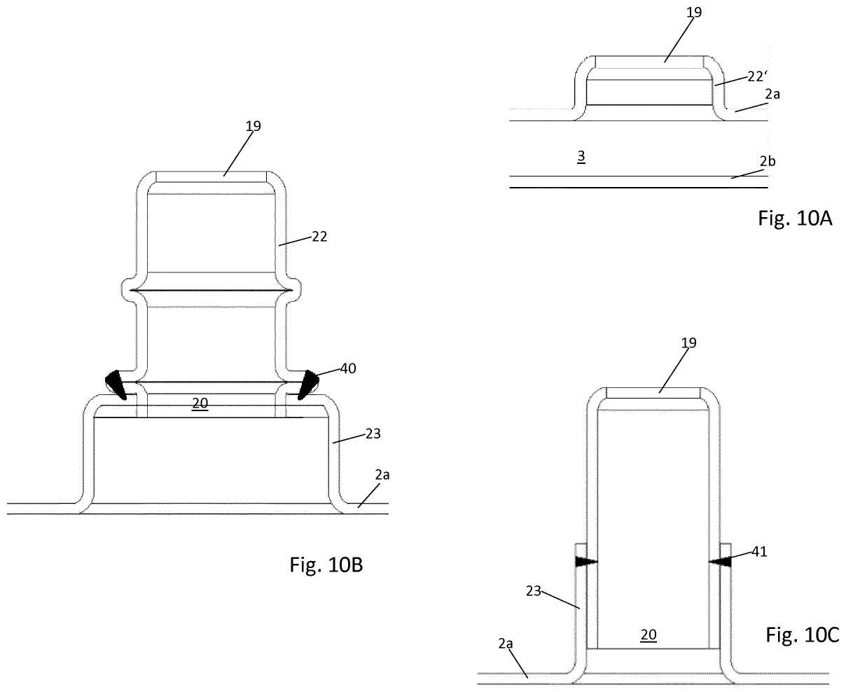

FIGS. 10A to 10C show details regarding connectors;

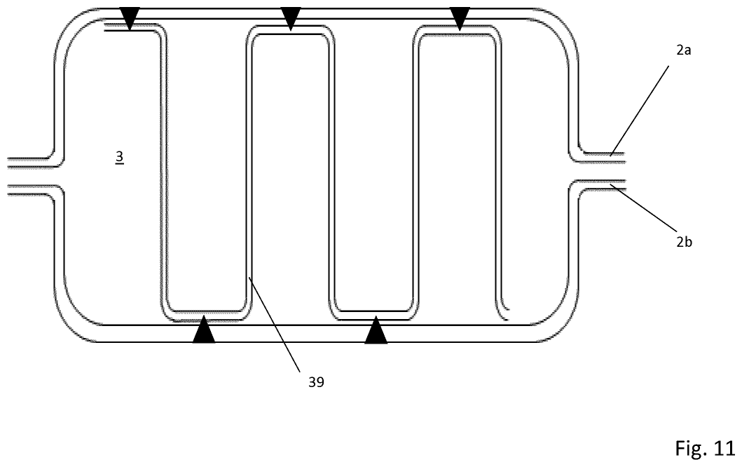

FIG. 11 shows a schematic representation of an attachment of a component for influencing the flow inside a cavity of a cooling plate; and

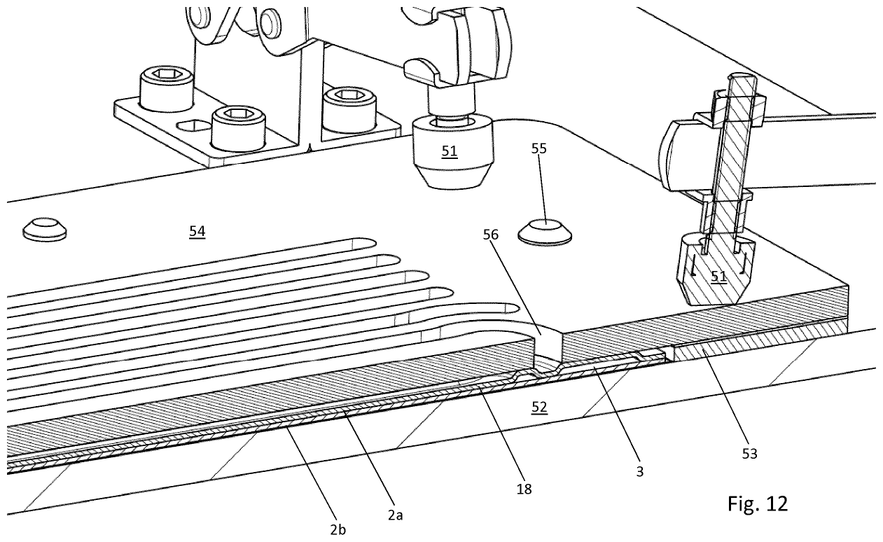

FIG. 12 shows a schematic representation of a detail of a clamping fixture of a cooling plate.

FIGS. 1A and 1B show oblique views of cooling plates according to the invention and of a respective vehicle drive battery 17 located thereabove. In FIGS. 1A and 1B, the cooling action at the battery is optimized in that, for example, a flat connection of the cooling plate to the battery is ensured. In addition, it shall be noted that the individual cooling plates each preferably have a single-layer design with respect to coolant conduction, that is, they have a single cavity for conducting liquid. In addition, several cooling plates are arranged horizontally next to one another so as to utilize the installation space in the vehicle in the best possible manner and, at a low height, cool the entire battery across the full surface area to the greatest extent possible. However, the invention also covers embodiments in which exactly one cooling plate is used.

The battery system 38 from FIG. 1A shows the battery 17 including cooling plates 1a to 1d located underneath, in which the individual cooling plates 1a to 1d are joined either in the plane of the cooling plates or beneath this plane. The battery system 38′ shown in FIG. 1B shows cooling plates 1a′ to 1d′ beneath the battery 17, wherein these cooling plates are connected to one another in a fluid-conducting manner by connectors 22, 22′ and lines on the visible surface of the cooling plates 1a′ to 1d′. In both instances, a single coolant circuit for all cooling plates located horizontally next to one another is made possible. In each case, two small cooling plates are arranged on the outside, and two large cooling plates are arranged centrally as an example of one installation situation, and in FIG. 1B there are media connections or connectors 22, 22′ between the sub-cooling plates. This is provided, in particular, when installation space constraints exist, in the event that it is not possible to install a single large plate or a plurality of exclusively identical plates. Moreover, such a modular design enables the use of a limited selection of standardized cooling plates.

FIG. 2A shows two substantially plate-shaped metal sections 2a and 2b in a cross-sectional view. These metal sections have a substantially complementary shape that is laterally reversed with respect to the mirror plane 8. The plates do not have to be laterally reversed. It is important that a shared contact surface is present, which can be joined. It is also possible for only one of the metal sections to include depressions, see FIG. 2B. The plate-shaped sections 2a and 2b have an uneven topography. A cavity 3, which is composed of a system of multiple mutually connected tunnels 29, is arranged between the metal sections on the surfaces thereof that face one another. Channels 29a, 29b are integrally formed in the individual metal sections 2a, 2b for this purpose. A tunnel 29 of the exemplary embodiment of FIG. 2B is formed by a single channel 29a, which directly abuts the metal section 2b. The cavity 3 or the system of the tunnel 29 is surrounded in a liquid-tight manner by a weld joint 7 extending substantially peripherally around the edge region 27a, 27b of the metal sections 2a, 2b, wherein openings for supplying and/or removing coolant, which are not shown in FIGS. 2A and 2B, are provided.

The metal sections 2a and 2b are joined to one another by different weld seams between the tunnels 29 or cavities 3. These include stitch welds 5, on the one hand, which are composed of consecutively arranged linear sections. Here, the distance between the linear sections located closest to one another is slightly larger than the respective length of a linear section, but this could be even larger. In addition, continuous welds 4 are shown, in which the seam does not stop at the free end thereof, but continues in such a way that an uninterrupted weld section is created, which is offset with respect to the actual weld and introduced in the opposite direction, whereby a loop-shaped section 4a is created. Moreover, wobble welds 9 are shown, that is, mutually overlapping single track seams. These are particularly preferred when welding is carried out with a very thin laser beam on a highly reflective material, such as aluminum The overlapping of the thin single track seam results in a stable joint, despite limited energy input. Finally, a continuous seam 7 provided in the edge region 27a, 27b is shown. In the figure, however, this continuous seam 7 is not closed since only a cooling plate that is separated in the middle is shown to ensure better visibility of the cavity 3. FIG. 2B shows further geometries of weld seams, for example a spot weld 10, which is advantageously used with steel plates. In addition, a seam 11 composed of cross stitches is shown, which offers advantages similar to those of the wobble weld. Finally, a wave weld 6 is shown.

All of the weld seams shown here were created by way of laser beam welding.

To avoid repetitions, reference is expressly made to the full scope of the introductory part of the description, including the refinements described there, with respect to details of the laser welding process and the laser beam welding device in which this was carried out. FIGS. 2A and 2B each shown different weld geometries between the tunnels 29 for demonstration purposes. In a practical setting, however, it is advantageous when a single type of weld is used in a cooling plate between the tunnels 29.

The detailed representation of FIG. 2C, in which section C of FIG. 2B is rotated by 90°, illustrates that it is completely sufficient when contact between the two metal sections 2a, 2b only occurs in a very narrow region. For this purpose, the metal section 2a is additionally partially embossed in the center of the depressions thereof, as is shown on the bottom side of the metal section 2a. In the embodiments of FIGS. 2A and 2B, the islands thus have a comparable length, but very different widths, which in FIG. 2B is thus approximately linear.

In the unwelded state, the thickness of each of the metal sections 2a, 2b is 0.2 to 1.5 mm, and the cut cooling plate shown in the figure, or the two metal sections 2a, 2b thereof, are made of an aluminum alloy.

The cooling plate can be an integral part of a system of cooling plates in which either a single or multiple such cooling plates are arranged next to one another in the bottom region of an electric vehicle (see FIGS. 1A and 1B), but may also be used alone.

The cooling plate according to the invention is, in particular, characterized by being cost-effective to produce, while also placing high demands on imperviousness.

FIG. 3 shows different embodiments of a cooling plate according to the invention, comprising double seal welds 12 to 15, a wobble weld 9 and different embodiments of loop-shaped sections 4a on a seam end. However, in addition, further embodiments of multiple seal welds are also possible; in principle, arbitrary numbers of multiple seal welds located next to one another can be implemented. For illustration purposes, Example A in FIG. 3 shows a detail of a cooling plate according to the invention, which shows parts of plate-shaped metal sections 2a and 2b, which are joined to one another sectionally by way of a double seal weld 12. The weld seams are all introduced as overlapping welds here, that is, essentially perpendicularly to the contact plane 33 of the two metal sections 2a, 2b.

According to Example A of FIG. 3, this double seal weld 12 is implemented by two weld seams extending parallel to one another.

Examples B to D show different further options of double seal welds. The seam line follows along the same path as the double seal weld 12 in Example A; however, for the sake of improved clarity, Examples B to D show only the weld line paths without further details of the cooling plate.

Example B shows a double seal weld 13. This is composed of multiple weld lines having a closed oval shape, wherein the ovals abut one another in a linear manner and overlap in regions.

Example C shows a double seal weld 14 in which rectangular chambers abut one another, thus forming the double seal weld 14.

Example D shows two periodically intersecting serpentine lines forming a double seal weld 15, which likewise separates individual chamber-like sections of the seam from one another.

Example E shows a continuous weld seam 9, which can be created in one operation, while nonetheless achieving the effect of a double seam. This corresponds to a script style without setting the pen down and is referred to as a “wobble weld.” A similar weld 9 is already shown in FIG. 2A.

With respect to all the Examples A to E, it shall be emphasized that all the options can be applied as described above with respect to the single weld seam.

In addition, the advantage of double seal welds is that the imperviousness of this double seal weld to liquid is considerably increased compared to simple seams.

Particularly high sealing is provided by the chamber systems according to Examples B to E since here, even in the case of leakage, only individual, mutually separated chambers are affected.

FIGS. 3F and 3G illustrate that a loop-shaped section 4a at the end of a seam is always composed of at least two seam sections adjoining from one another. Depending on the installation space, a symmetrical division of the two seam sections (Example F), or an asymmetrical division of the two seam sections (Example G), with respect to the width of the actual, ending seam can be carried out.

A particularly advantageous aspect of the present invention is that the heat input during the production of cooling plates is minimized since warping is to be expected, in particular with thin metallic plates, which should absolutely be minimized. Very thin metal plates are very important in cooling applications for the mobile field, where weight plays a major role.

According to the invention, this minimization is achieved in a variety of ways.

For one, a laser beam welding device is to be provided, such as will be described by way of example in the context of FIG. 12, which is used to create intermittent seams for creating a welded joint, and in particular a laser-welded joint, of the two plates which make up the cooling plate. In particular, “scanner welding” is an obvious choice here. In this process, as was described in detail above, the laser beam is deflected by way of at least one mirror, so that spatial jumps are possible during laser welding essentially without loss of time, that is, it is not necessary to create a continuous weld seam. Care should be taken in this regard to ensure that different regions of the plate are welded alternately, so as to achieve homogenization of the heat input, both in terms of space and time, so that the plate is heated uniformly, and not excessively, during the welding process. This is a considerable advantage over welding progressing from only one spot, which would cause the cooling plates to become warped.

In addition, it is also possible to supply protective gas on the outer sides of what will later constitute the cooling plate, since this minimizes oxidation in the region of the weld seams, and thereby avoids oxide deposits later in the process. In this way, the efficiency of a later cooling plate is increased yet again.

The intermittent weld lines can take on a wide variety of embodiments and can be consecutive punctiform weld joints, or curved or straight weld lines, or alternately weld lines and spot welds. It is optimal in this process when the distance between two weld elements (that is, lines or spots) is between 1 and 8 cm, and preferably between 2 and 6 cm. Preferably, in particular, the distance between two weld elements is at least exactly the size of, and preferably at least 1.5 times the size of, the length of such a weld element, and in the case of weld elements having differing lengths, of the longer one. The minimum length of welded regions should always be such that secure cohesion of the two plates is ensured, even if the liquid pressure inside the cooling plate is high, so that no “inflation” occurs.

For this purpose, two plates are preferably placed against one another without gaps in the laser beam welding device, and are then welded together. In addition, however, the mechanical stability is also increased. Moreover, improved bearing of the thus “planar” cooling plates on the components to be cooled is possible, and contact problems occur less frequently. In addition, it shall be noted that specifically oriented weld joints in the region of the coolant channels allow the flow of media to be controlled by the weld joints. This means that the cooling medium flowing inside the cavity of the cooling plate is regulated, so as to achieve even more uniform heat distribution and increase the efficiency of the cooling plates.

FIG. 4A shows an example of a cooling plate in which two metal sections 2a and 2b enclose a respective interior cavity 3, within which weld joints are provided in the region of islands 18 for fluid control and/or to prevent “inflation” under operating pressure. For installation, the cooling plate comprises bolts 21. A tab 30 is provided for potential equalization. Openings 19 allow fluid to be supplied and removed. These fluid openings 19 are designed as receiving openings 20 for separate connectors 22, which are affixed in the edge region of the cooling plate.

FIG. 4B shows a sectional view of a detail from FIG. 4A. Here, the separate connector 22 can be seen well again, which is inserted into a receiving opening 20 in the edge region of the two metal sections 2a and 2b. The through-opening of the connector thus serves as the actual fluid opening 19.

FIG. 4C shows a further example of a cooling plate, in which a bolt 21 is partial cut. A separate connector 22 is accommodated between the sections 26a, 26b of the metal sections 2a and 2b which are curved away from one another in an approximately semi-circular manner and which form a receiving opening 20. In the surface plane 33 to the left and right of the separate metal connector, a residual cavity/residual gap 31 can be seen between the two metal sections 2a and 2b, which can be closed, for example, by using solder, which is not shown here, in particular during laser welding, and in particular when the peripheral weld seam 7 is introduced in the edge region 27, which is not shown here so as to illustrate the residual cavities 31. An alternative option for closing or avoiding the residual cavity/residual gap 31 will be addressed in more detail in connection with FIGS. 8A to 8C. The sections 26a, 26 curving in a substantially semi-circular manner start directly on the outer edge 24a, 24b of the respective metal section 2a, 2b.

FIG. 4D illustrates a detailed top view of how the two metal sections 2b, 2b are joined to one another in the region of an island 18, that is, of a locally delimited region in which the two metal sections 2a and 2b rest on top of one another, by way of an annularly closed, here substantially oval, continuous weld seam 16. The illustration of the plate at the bottom was dispensed with.

FIG. 5, in turn, shows an example of a cooling plate 1 that has not been joined yet, in which a metal section 2a (FIG. 5A) is provided with impressed channels, and a section 2b (FIG. 5B) is designed without embossing/deformation, that is, is only planar. Fluid openings 19 are provided in the planar metal section 2b, a respective region not containing any structures that are divided into small sections being located opposite of the fluid openings in the embossed metal section 2a, whereby larger “lakes” are formed in the joined cooling plate 1 in the regions of the cavity 3 adjoining the fluid openings 19. The example is designed in such a way that the actual tunnels or coolant channels extend parallel to one another, and more specifically in such a way that an overall U-shaped path results, in which the tunnels are merged in the region of the bend of the U shape.

FIGS. 6A to 6C show an assembled version in which the metal sections 2a and 2b are welded together, for example also at the end faces by an edge weld joint. Moreover, a further metal section 2c is welded onto the section 2b. Separate connectors 22 are then again applied to this profiled sheet metal 2c. All of the above-described joints are carried out by way of laser welding.

FIGS. 7A to 7D show examples of connectors 22 welded onto metal sections 2a or 2b. In FIG. 7A, a connector 22 is welded onto the metal section 2a concentrically around the opening 19 of the connector, and around the opening of the metal section 2a, by way of a double seam 12. Instead of a double seam 12, a single seam, that is, only 12a, would likewise be possible, so that the outer seam 12b is not shown in solid form here. The connector comprises at least one extension 22a so as to simplify the positioning of connector 22 in the opening of the metal section 2a. This extension can be designed to be peripheral, as is shown, but may also only be composed of individual sections.

FIG. 7B differs from FIG. 7A in that the weld seam is designed as a simple seam 16 and is introduced from beneath, that is, the side of the metal section 2a located closer to the metal section 2b in the finished cooling plate 1, whereas the weld seams of FIG. 7A are introduced from the other surface.

In FIG. 7C, the connector is considerably longer toward the bottom, whereby welding to the opposing metal section 2b is made possible. The connector 22 is thus welded both to the metal section 2a and to the metal section 2b by respective continuous simple seams 16′, 16. Recesses 19a in the lower region of the connector 22 allow fluid to be supplied to or removed from the cavity 3 by way of the connector 22. As an alternative, the weld joint between the connector 22 and the metal section 2b may also be dispensed with (that is, no weld seams 16 in FIG. 7C).

FIG. 7D differs from FIG. 7C in that the connector is welded to the metal section 2a from beneath, that is, the surface of the metal section 2a located closer to the metal section 2b in the finished cooling plate. FIG. 7C shows a semi-finished state, and a second metal section 2b can subsequently be welded on, as in FIG. 7D. However, the connector 22 can only be welded to the metal section 2a in the present configuration as long as the second metal section has not been applied yet. Compared to the preceding joining options for connectors 22 shown in figure group 7, the embodiment of FIG. 7D offers the advantage that the internal pressure pushes the connector against the metal section 2a and thereby supports the attachment.

FIG. 8A shows a schematic detail of a region around a receiving opening 20 from FIG. 4C. The receiving opening 20 is spanned by two sections 26a, 26b of the edge regions 27a, 27b of the metal sections 2a and 2b which are curved away from one another. Reference numeral 35 denotes what will later be the contact regions between the receiving opening 20 and a connector accommodated therein. Arrows 31 denote a region at the interface of the metal sections 2a and 2b which deviates from the ideal circular shape on both sides. If left in the state as shown, this region leaves a respective cavity free on each side of the connector 22, which is not shown here, which is to be avoided to ensure the best sealing action possible in the region of the receiving opening 20.

FIG. 8B represents a variant of FIG. 8A, in which the aforementioned residual cavity/residual gap 31 is reduced to a minimum, so that the region 31′ deviating from the ideal circular shape is negligibly small or even non-existent. This was achieved by subsequent deformation of the transition regions of the curved sections 26a, 26b to the horizontally extending sections 25a, 25b of the metal sections 2a, 2b in a mechanical forming process, so that the “corners” were displaced in the direction of the center of the virtual circle. The two metal sections 2a, 2b are shown in the state where these are placed on top of one another, so as to illustrate the reduction of the residual cavity/residual gap from 31 to 31′. The mechanical forming process for each of the metal sections 2a, 2b is preferably carried out separately from the other metal section 2b, 2a. Mechanical forming can be carried out, as is shown, across the entire axial length of the receiving opening 19. However, in principle it is sufficient when forming is only carried out in one section of the axial extension of the receiving opening 19. FIG. 8B shall be understood to mean that the receiving opening 19 must be large enough to ensure sufficient clearance for inserting a connector. The required imperviousness is usually established when welding the connector to the two metal sections 2a, 2b.

FIG. 8C illustrates that an embossing extending completely around the curvature can be present in a metal section 2a in the region of a curvature 26a, which ensures that this region has a semi-circular shape or, after the two metal sections have been placed on top of one another, a full circular shape, in the cross-sectional view. As is apparent from FIG. 8C, the peripheral embossing does not have to extend over the entire axial path of the receiving opening 20, but rather it is sufficient if this extends only sectionally in the axial direction. As was already mentioned above, the receiving opening 19 is to still have sufficient clearance at the narrowest cross-section thereof to allow a connector to be inserted, and imperviousness here as well is preferably achieved by welding the connector in place.

FIGS. 9A and 9B illustrate, in top views of the edge region 27a of a metal section 2a, that a curvature 26a for configuring a receiving opening 20 can be integrally formed not only in the direct continuation of the outer edge 24a, as shown in FIG. 4C. Rather, it is also possible to interrupt the outer edge 24a on both sides to form such a curvature 26a, or to pull the outer edge inwardly, as is illustrated in FIG. 9A. In addition to the remaining outer edge 24a, this results in outer edge sections 24a′ that are retracted on both sides to the receiving opening 20, and an outer edge section 24a* that protrudes in relation thereto, which here corresponds to a continuation of the outer edge 24a, but could also be either slightly recessed or slightly protruding in relation thereto. The interruptions 34, 34′ can be implemented as simple rectangles that are rounded at the edges. Advantageously, however, these are designed so as to have the smallest width in the regions in which the curvature 26a is the most pronounced, which in the present example is in the region directly adjoining the virtually continuing outer edge 24a or the outer edge 24a* of the receiving opening 20. In this way, a particularly large amount is available for configuring the curvature 26a. It is likewise apparent from FIG. 9A that the width of the receiving opening or curvature decreases toward the inside of the cooling plate. Advantageously, however, not only the width decreases, but the radius, whereby a funnel-shaped transition, which is denoted by reference numeral 26′ here, to the actual cavity 3 is formed.

As an alternative to configuring recesses 34, 34 in the metal section 2a adjoining the receiving opening 20, it is also possible to design the receiving opening 20 so as to protrude beyond the remaining outer edge 24a, so that it has its own protruding outer edge 24a*, as is shown in FIG. 9B. The remaining design of the curvature 26a corresponds to that of FIG. 9A.

FIG. 10A again shows a schematic example of a cross-section of the metal sections 2a and 2b. A connector 22′ that is integral with the metal section 2a and exposes a fluid opening 19 toward the cavity 3 is shown here.

FIG. 10B shows an embodiment in which a separate connector 22 is provided, which is introduced into a prefabricated cup 23 of the metal section 2a and is welded thereto. The overlapping weld 40 is introduced obliquely relative to the axial direction of the connector 22, since in this way adjoining elements do not impede the laser beam. The prefabricated cup 23 forms a receiving opening 20 here, and in contrast to many preceding exemplary embodiments, the receiving opening 20 is formed out of a single metal section 2a here. So as to create the receiving opening, first a through-opening is introduced, and thereafter the region surrounding the through-opening is subjected to a forming operation.

FIG. 10C shows a particularly simple embodiment of a cooling plate comprising a separate connector 22 attached thereto by welding. The metal section 2a includes a cylindrical receiving opening 20 into which the connector 22 is inserted. Attachment and sealing are achieved by a peripheral weld seam 41 extending perpendicularly to the axial direction of the connector 22, the weld seam again being designed as an overlapping weld. As an alternative or in addition to this weld seam 41, the receiving opening can be provided with a thread, such as by milling in the same and later screwing in a connector. The connector can already include a complementary thread for this purpose, or can be provided with a thread in a self-cutting manner when the connector blank is screwed in. As an alternative, it is also possible that a thread is created in a self-cutting manner in the jacket of the receiving opening 20 by screwing in a connector that is provided with an external thread. In any case, the threaded joint can be additionally secured by gluing/soldering and/or welding, in particular laser welding.

FIG. 11 schematically shows a flow-influencing component, for example a corrugated component inside a cavity 3 between a metal section 2a and a metal section 2b. The component 39 is fixed inside the cavity from the outside (both sides) by laser welding, so that respective sections of the component 39 are joined to sections of either the metal section 2a or of the metal section 2b.

FIG. 12 shows a clamping fixture 50 for welding together two metal sections 2a, 2b. In the shown detail, the clamping fixture comprises a lower guide plate 52, a lateral guide plate 53, an upper guide plate 54, from which a free end of a pin 55 of the lower guide plate protrudes, and multiple clamps 51. In the shown detail, multiple radiation cut-outs 56 are apparent in the upper guide plate 52. Similar cut-outs are present in other locations in the lower guide plate so as to avoid attachment by welding, but are not visible here.

Further details regarding the teaching according to the invention can also be found in the claims. It shall be pointed out that the products of the production method claims can, of course, also be claimed individually and explicitly again as products, with the described features. Furthermore, unless explicitly indicated by references to claims, all claims can be combined with one another.

In addition, however, the following aspects can also be combined with these claims or arbitrary portions of the present intellectual property right application, for example with one of the following aspects, wherein these may also be arbitrarily combined with one another:
1. A method for producing a cooling plate for electric batteries, wherein two substantially flat metal sections are joined by laser beam welding (with or without additional solder), the substantially flat plate-shaped metal sections being arranged sectionally on top of one another without gaps during the laser welding process, and, so as to reduce the heat input during welding, the weld seams are implemented as linear sections that are arranged consecutively, but at a distance from one another in the region of joining areas of a liquid-tight cavity between the metal sections, preferably
2. metal sections having a thickness of 0.2 to 1.5 mm being used (it also being possible to join metal sections having differing thicknesses to one another, which can also be made of different alloys),
3. for example, exactly two flat plate-shaped metal sections being arranged sectionally on top of one another without gaps during the laser welding process, and, so as to reduce the heat input during welding, the weld seams being designed as linear sections that are arranged consecutively, but at a distance from one another, and/or
4. the horizontal distance between two linear elements of an intermittent weld seam being between 1 and 8 cm, and preferably between 2 and 6 cm,
5. for example, different regions of the metal sections to be joined being alternately welded so as to achieve homogenization of the heat input, both in terms of space and time,
6. for example, a linear section of the weld seams being curved, and/or
7. an additional circular movement of the laser beam being carried out during the linear movement.

1-33. (canceled)

34. A method for producing a cooling plate for cooling an electric battery for an electric vehicle, wherein at least two plate-shaped metal sections are joined to one another, forming a cooling plate, the joining of the metal sections being carried out by laser beam welding.

35. The method according to claim 34, wherein the laser welding is carried out by way of a fiber, YAG, CO₂ and/or diode laser, in each case with or without the addition of solder between the sections to be joined.

36. The method according to claim 34, wherein the laser beam welding is carried out in a laser beam welding device, this device comprising a clamping fixture for fixing the metal sections to be welded together and a beam head for emitting one or more laser beams.

37. The method according to claim 36, wherein the clamping fixture and/or the beam head are movably guided,
and/or
wherein the beam head comprises a movable mirror system for beam guidance, wherein different regions of the metal sections to be welded together can be activated in accordance with the mirror movement,
and/or
wherein the clamping fixture regionally embraces the metal sections in a form-locked manner,
and/or
wherein the clamping fixture is designed in such a way that the plate-shaped metal sections are arranged sectionally on top of one another without gaps during laser welding,
wherein the clamping fixture comprises a unit for conducting protective gas to the region to be welded,
and/or
wherein the clamping fixture, on the top side facing the beam head, includes a radiation cut-out for conducting a laser beam through onto a metal section,
and/or
the clamping fixture, on the bottom side facing away from the beam head, includes a welding cut-out to prevent a metal section from being welded in place.

38. The method according to claim 34, wherein the welding in the edge region of the metal sections is carried out essentially peripherally so as to create a liquid-tight cavity between the metal sections.

39. The method according to claim 38, wherein opposing metal sections within the liquid-tight cavity are welded together so as to form “islands”.

40. The method according to claim 34, wherein overlapping welds are introduced in the case of overlapping metal sections to be joined, and/or an end face weld is introduced when edges of metal sections to be joined bear flush on one another, and/or fillet welds are introduced when metal sections are to be welded together at edges that are not flush, for joining purposes.

41. The method according to claim 37, wherein the cavity includes at least one fluid opening for supplying and/or removing coolant.

42. The method according to claim 39, wherein the thickness of the metal sections is 0.2 to 1.5 mm in the unwelded state.

43. The method according to claim 34, wherein the material of the sections is aluminum, aluminum alloys, copper, copper alloys, metallized plastic or stainless steel, and an aluminum alloy of the 3xxx group or the 5xxx group.

44. The method according to claim 38, wherein the plate sections are welded together in the region of the cavity at least regionally by weld spots, stitch welds, multiple seal welds, circular or oval seal welds or wave welds, or mutually overlapping single track welds.

45. The method according to claim 34, wherein the seam ends are reinforced by opposing, laterally offset seam sections, and in particular loop-shaped seam sections, which are preferably connected to the seam end.

46. The method according to claim 34, wherein at least one of the metal sections is deformed by way of embossing, deep drawing and/or another forming method, configuring at least one channel.

47. The method according to claim 34, wherein at least one of the metal sections comprises integral tabs for positioning a battery to be cooled and/or for potential equalization, and/or webs or bolts for receiving the battery in a form-locked manner and/or for attaching the cooling plates and/or the battery to a frame of a vehicle.

48. The method according to claim 34, wherein the metal sections to be joined differ in terms of composition and shape, wherein the metal sections have differing thicknesses and/or to comprise differing alloys and/or differing embossings.

49. The method according to claim 34, wherein a connector and/or a receiving opening are integrally formed out of at least one of the metal sections.

50. The method according to claim 49, wherein at least one connector and/or a receiving opening are integrally formed out of a flat section of one of the metal sections, the method including at least one cutting and/or stamping step and at least one embossing, deep drawing and/or other forming step.

51. The method according to claim 50, wherein at least one connector and/or a receiving opening are integrally formed out of an edge section of two metal sections, the method including at least one embossing, deep drawing and/or other forming step and at least one welding step.

52. The method according to claim 51, wherein the connector and/or the receiving opening comprise an outer edge protruding beyond the remaining outer edge, or the edge section includes a cut-out on at least one side of the connector and/or of the receiving opening.

53. The method according to claim 34, wherein at least one connector is designed as a separate component and is welded to at least one of the metal sections in the region of a receiving opening.

54. The method according to claim 53, wherein a separate connector is inserted into a through-opening of a metal section in such a way that the connector is supported at least regionally on an opposing metal section, which also delimits a cooling cavity, and that the separate connector is welded to one or both aforementioned metal sections.

55. The method according to claim 53, wherein, in the edge region of two metal sections bearing on one another in a finished cooling plate, a respective approximately semi-circular curvature is formed so as to configure a receiving opening for a separate connector in a finished cooling plate, and thereafter
in a state where the metal sections are still separate, a subsequent deformation of the metal sections is carried out in what will later be the contact region with the separate connectors so as to close residual gaps, and/or
in the state of the metal sections in which these are still separate, or when these have already been placed on top of one another, solder is introduced so as to close residual gaps, and
thereafter, after the metal sections have been placed on top of one another, laser welding of the metal sections is carried out, on both sides, so as to connect the separate connector in a liquid-tight manner to the metal sections in the region of the existing residual gaps.

56. The method according to claim 53, wherein the separate connector is connected to a cup-shaped configuration of a metal section.

57. The method according to claim 34, wherein a component for influencing the flow is fixed inside a cavity between two metal sections by way of laser welding.

58. A cooling plate for cooling batteries in electric vehicles, wherein the cooling plate comprises at least two metal sections that are welded together.

59. The cooling plate according to claim 58, wherein the cooling plate is provided at least regionally with a weld that is intermittent so as to reduce the heat input during welding.

60. The cooling plate according to claim 58, wherein a connector or a receiving opening projects from at least one metal section, the connector and/or the receiving opening being integrally formed from the at least one metal section.

61. The cooling plate according to claim 58, wherein a connector is attached to or inserted into at least one metal section by welding in the region around a receiving opening.

62. The cooling plate according to claim 58, wherein at least one connector, which is formed of a respective edge section of the two metal sections that are welded together, is configured on an edge section of the cooling plate, the two edge sections being welded together at least sectionally.

63. The cooling plate according to claim 58, further comprising single-layer coolant conduction.

64. The cooling plate according to claim 58, further comprising multiple sub-cooling plates, these sub-cooling plates essentially adjoining one another in one plane and being connected to one another by connectors and/or lines for conducting coolant.
